(19) United States
(12) Patent Application Publication
(10) Pub. No.: US 2012/0099149 A1
(43) Pub. Date: Apr. 26, 2012

(54) PRINTING SYSTEM AND PRINTER

(75) Inventor: Toyoshi INOUE, Nagoya-shi (JP)

(73) Assignee: BROTHER KOGYO KABUSHIKI KAISHA, Aichi-ken (JP)

(21) Appl. No.: 13/273,690

(22) Filed: Oct. 14, 2011

(30) Foreign Application Priority Data
Oct. 20, 2010 (JP) 2010-235136

(51) Int. Cl. G06K 15/02

(52) U.S. Cl. 358/1.15

(57) ABSTRACT

A printing system includes: a first printer; and an information processing apparatus configured to register a print job in the first printer. The first printer comprises: a decision unit configured to decide a selection condition for selecting the print job to be printer; a determination unit configured to determine whether the print job corresponding to the selection condition decided by the decision unit is registered in a second printer; and a notification unit configured to notify a user of identification information of the other printer if the determination unit determines that the print job corresponding to the selection condition is registered in the second printer. The first printer to which the print job is registered starts printing in response to a print instruction.

### CROSS-REFERENCE TO RELATED APPLICATION

This application is based upon and claims the benefit of priority of Japanese Patent Application No. 2010-235136 filed on Oct. 20, 2010, the contents of which are incorporated herein by reference in its entirety.

### BACKGROUND

The present disclosure relates to a printing system and a printer. More particularly, the present disclosure relates to a printing system which includes a plurality of printers, registers a print job in any one of the printers and starts printing in response to a printing instruction for the print job.

There have been technologies for registering print jobs in printers and instructing the registration destination printers so as to print the print jobs. For example, such a system is known that the same secure job is registered in a plurality of printers, that any one printer starts printing of a secure job after performing authentication, etc.

### SUMMARY

However, those printing systems according to the related art have the following problem. That is, in an environment in which a printer in which a print job has been registered exists together with printers in which the print job has not been registered, unless a user knows which printer the print job has been registered in, the user may not obtain a desired printout.

An aspect of the disclosure was made in order to solve the problem of the printing system according to the related art. That is, an object is to provide a printing system and a printer which can find out the whereabouts of a registered print job.

A printing system according to the aspect of the disclosure comprises:

a first printer; and

an information processing apparatus configured to register a print job in the first printer,

wherein the first printer comprises:
a decision unit configured to decide a selection condition for selecting the print job to be printer;
a determination unit configured to determine whether the print job corresponding to the selection condition decided by the decision unit is registered in a second printer; and
a notification unit configured to notify a user of identification information of the other printer if the determination unit determines that the print job corresponding to the selection condition is registered in the second printer,

wherein the first printer to which the print job is registered starts printing in response to a print instruction.

A printer according to the aspect of the disclosure comprises:

a storage configured to store printing jobs therein;

a decision unit configured to decide a selection condition for the printing job to be printed;

a printing instruction unit that instructs printing of the print job which is stored in the printing job and corresponds to the selection condition decided by the decision unit;

a printing unit configured to execute printing in response to an instruction of the printing instruction unit;

a determination unit configured to determine whether the print job corresponding to the selection condition decided by the decision unit is registered in any other printer; and

a notification unit configured to notify a user of identification information of the other printer if the determination unit determines that the print job corresponding to the selection condition is registered in the other printer.

### BRIEF DESCRIPTION OF DRAWINGS

FIG. 1 is a block diagram illustrating a configuration of a printing system according to an embodiment.

FIG. 2 is a block diagram illustrating an electrical configuration of a PC and a printer included in the printing system.

FIG. 3 is a block diagram illustrating an outline of secure printing.

FIG. 4 is a diagram illustrating a configuration of a database that stores information common to printers.

FIG. 5 is a diagram illustrating a configuration of a database that stores information on a printer.

FIG. 6 is a flow chart illustrating a procedure of a job transmission process of the PC.

FIG. 7 is a flow chart illustrating a procedure of a job reception process of a printer.

FIG. 8 is a flow chart illustrating a procedure of a job display process of a printer.

FIG. 9 is a flow chart illustrating a procedure in which a printer generates a list of jobs of the other printers.

FIG. 10 is a diagram illustrating an example of a list of jobs of a printer in a case where the printer has a print job of an authenticated user.

FIG. 11 is a diagram illustrating an example of a list of jobs of the other printers than a printer having no print job of an authenticated user.

FIG. 12 is a flow chart illustrating a procedure of a registered-job printing process of a printer.

### DESCRIPTION OF EXEMPLARY EMBODIMENTS

Hereinafter, a printing system according to an exemplary embodiment will be described in detail with reference to the accompanying drawings. The printing system according to the present embodiment includes a plurality of printers and a personal computer (PC) for registering secure jobs in the plurality of printers.

### Entire Configuration of Printing System

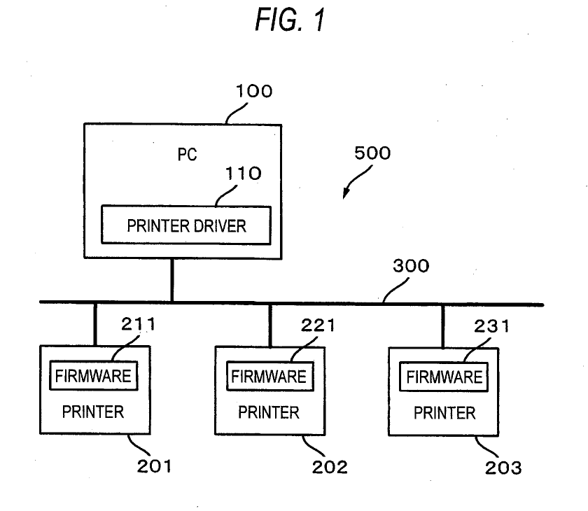

A printing system 500 according to the exemplary embodiment includes printers 201, 202, and 203 having a secure print function and a PC 100 for outputting print data to the printers, as shown in FIG. 1. The printers 201, 202, and 203 need not necessarily be the same model (type), and may be different from one another. In the printing system 500, the PC 100 and the printers 201, 202, and 203 are connected to one another through a network 300 such as Ethernet (a registered trademark).

The PC 100 includes a printer driver 110 for outputting print jobs corresponding to the printers 201, 202, and 203. The printer driver 110 of the present embodiment is a universal driver capable of dealing with a plurality of printer types, and generates print jobs according to the specifications of the printers 201, 202, and 203. The printer driver 110 of the PC 100 is not limited to a universal printer driver, but may be configured by incorporating printer drivers corresponding to the printers.

The printer 201 includes firmware 211 for controlling an image forming unit, a manipulation unit, and the like. The other printers 202 and 203 also include firmware 221 and firmware 231 according to their types, respectively.

In the present embodiment, the printing system 500 includes one PC and three printers. However, the present invention is not limited thereto. The printing system 500 may include one or more PCs and one or more printers. Also, the printing system 500 may be connected to other information processing apparatuses or image processing apparatuses.

### Configuration of PC

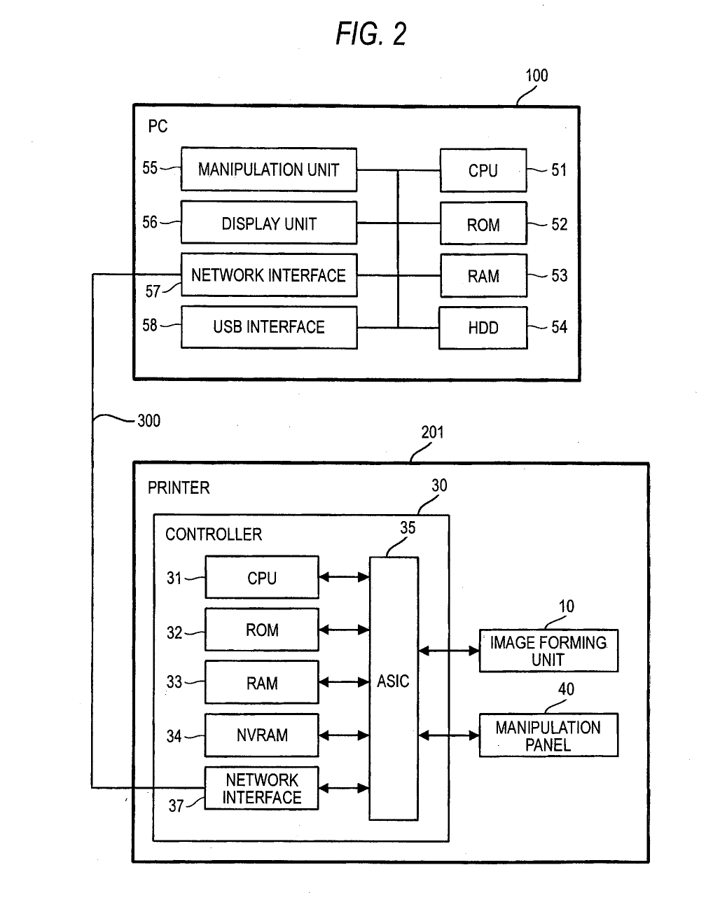

Subsequently, a schematic configuration of the PC 100 will be described. The PC 100 includes a CPU 51, a ROM 52, a RAM 53, a HDD 54, a manipulation unit 55 such as a keyboard and a mouse, a display unit 56 composed of a liquid crystal display or the like, a network interface 57, and a USB interface 58, as shown in FIG. 2.

The HDD 54 (an example of a search-result storage unit and a search condition storage unit) of the PC 100 stores an operating system (OS), device drivers for controlling various kinds of devices, application programs, such as a word processor and a spreadsheet program, having printing instruction functions, and the like. The printer driver 110 also is stored in the HDD 54.

The CPU 51 (an example of a designation unit, a search unit, a determination unit, a transmission unit, a prohibition unit, a selection unit, and a setting unit) executes various kinds of processes while storing computation results in the RAM 53 or the HDD 54 in accordance with control programs read from the ROM 52, application programs read from the HDD 54, and the like. The operation of the printer driver 110 also is processed by the CPU 51.

The network interface 57 and the USB interface 58 are interfaces enabling communication with external devices. In the present embodiment, the PC 100 performs data communication with the printer 201 and others through the network interface 57.

### Configuration of Printer

Subsequently, a schematic configuration of the printer 201 will be described. The printer 201 includes a control unit 30 which includes a CPU 31, a ROM 32, RAM 33, a non-volatile RAM (NVRAM) 34, an ASIC 35, and a network interface 37, as shown in FIG. 2. The control unit 30 is electrically connected to an image forming unit 10 for forming images on sheets, and a manipulation panel 40 for displaying operation states and receiving input manipulation of a user. The printers 202 and 203 have almost the same configuration as that of the printer 201, and thus the redundant description will not be repeated.

The ROM 32 stores the firmware 211 which is a control program for controlling the printer 201, various kinds of set options, initial values, etc. The RAM 33 is used as a work area to which various kinds of control programs are read, or a storage area which temporarily stores image data.

The CPU 31 controls the individual components of the printer 201 through the ASIC 35 while storing process results in the RAM 33 or the NVRAM 34 in accordance with control programs read from the ROM 32 and signals transmitted from various kinds of sensors. The operation of the firmware 211 also is processed by the CPU 31.

The network interface 37 is an interface enabling communication with external devices. In the present embodiment, the printer 201 performs data communication with the PC 100 and others through the network interface 37.

### Outline of Secure Printing

Subsequently, secure printing of the printing system 500 will be described. In the printing system 500 of the present embodiment, a secure job which is a print job requiring user authentication is transmitted to a desired printer. If receiving the secure job, the printer registers the secure job in the memory and enters a printing standby state. Then, if user authentication is executed in the printer, printing of the secure job of the user is executed. Hereinafter, printing using this secure job is referred to as secure printing.

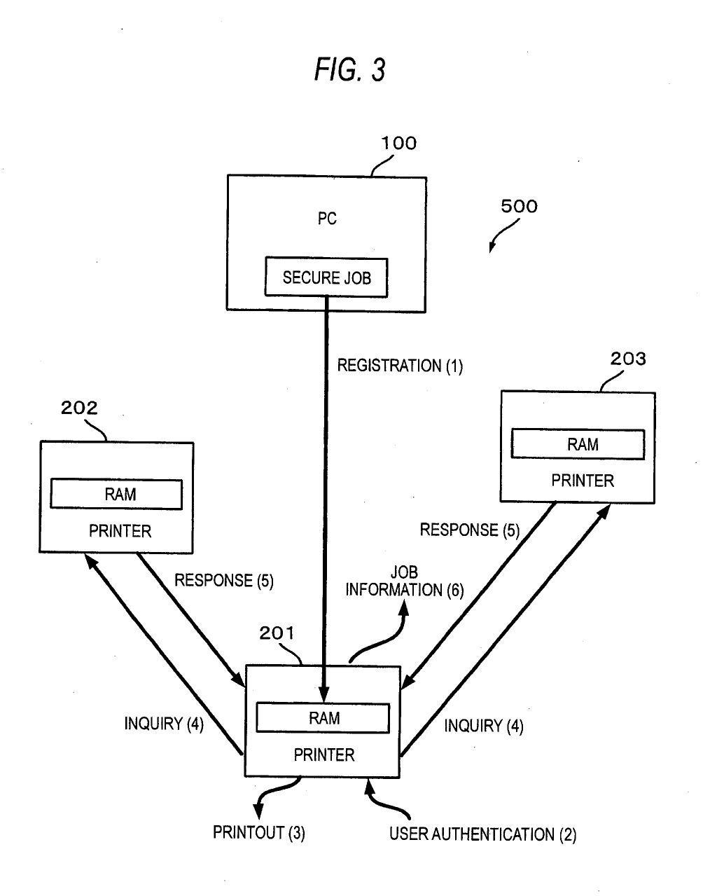

Specifically, in the printing system 500, as shown in FIG. 3, the PC 100 generates a secure job, transmits the secure job to a desired printer (hereinafter, referred to as a transmission destination printer) (the printer 201 in FIG. 3) of the printing system 500, and registers the secure job in the NVRAM 34 or RAM 33 of the transmission destination printer (registration (1)).

Then, the user selects any one of the printers of the printing system 500 and inputs information required for user authentication to the selected printer (user authentication (2)). In a case where the selected printer is the transmission destination printer (the printer 201 in FIG. 3) of the secure job, if the user is authenticated, the selected printer extracts secure jobs registered by the authenticated user, from secure jobs registered therein, and displays a list of the extracted secure jobs. Then, if the authenticated user selects a secure job from the displayed list of secure jobs, the selected printer starts printing the selected secure job.

Meanwhile, in a case where the selected printer is not the transmission destination printer, that is, in a case where the selected printer is a printer (the printer 202 or 203 in FIG. 3) in which the authenticated user has not registered any jobs, the selected printer inquires of the other printers about information regarding print jobs of the authenticated user (inquiry (4)). Then, the other printers respond the information regarding the print jobs of the authenticated user (response (4). If receiving the responses, the selected printer outputs the received information (job information (6)).

Printing of the secure job does not start until the user is authenticated. Therefore, other people cannot see the printout or take the printout away, and thus confidentiality is high. Moreover, printing of confidential documents can be supposed on the basis of the high confidentiality, and thus demand for the reliability of printing also is high. Also, even if the user is authenticated by a printer in which the secure job has not been registered, since information on the other printers is output, it is possible to grasp which printer a desired secure job has been registered in.

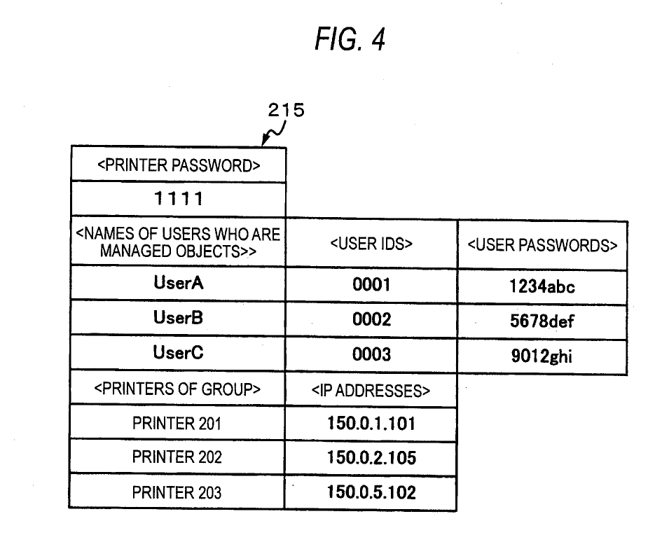

The printers 201, 202, and 203 are in a group, and each of the printers 201, 202, and 203 has a database 215 storing information common to the group as shown in FIG. 4. Specifically, the database 215 stores a printer password common to the group, names of users which are managed objects, user IDs and user passwords assigned to the users, names of the printers belonging to the group, and IP addresses of the printers. Hereinafter, the database 215 is referred to as the management DB 215.

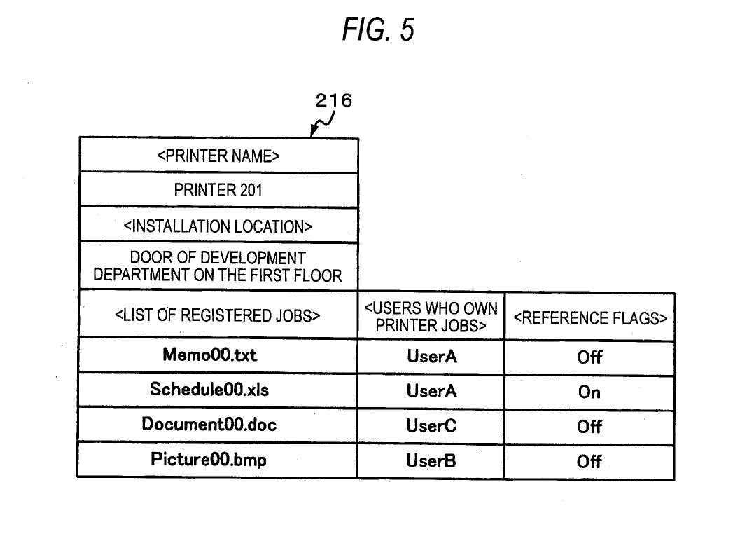

Each of the printers 201, 202, and 203 also has a database 216 storing information on the corresponding printer as shown in FIG. 5. Specifically, the database 216 stores the printer name, information indicating the installation location of the printer, registered job names, users who own jobs, and reference flag information. That is, in the database 216, as a record of job information of a print job, the job name, the user who owns the print job, and a reference flag are stored. The reference flag will be described below in detail. Hereinafter, the database 216 is referred to as the printer DB 216.

### Secure Printing Operation

Subsequently, a procedure of the above-mentioned secure printing is divided into an operation of the PC 100 and an operation of the printers 201, 202, and 203 each of which will be described in detail. In the following description, an operation of the printer 201 will be described. The printers 202 and 203 execute the same operation as that of the printer 201.

### Job Transmission Process (PC)

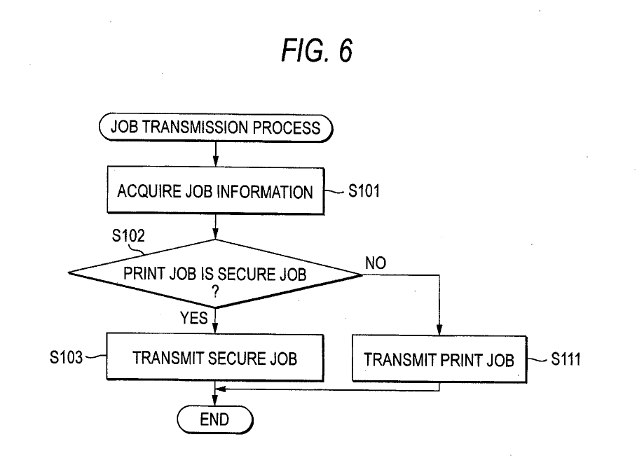

Above all, a job transmission process executed by the printer driver 110 of the PC 100 will be described with reference to a flow chart of FIG. 6. If receiving a printing instruction through, for example, an application program, the printer driver 110 executes the job transmission process.

First, in step S101, the job information of the print job is acquired. In step S101, particularly, set information on whether the print job is a secure job or not is acquired. Then, in step S102, on he basis of the job information acquired in step S101, it is determined whether the print job of which printing has been instructed is a secure job or not.

If the print job is a secure job (Yes in step S102), in step S103, information on the printer selected as the registration destination of the secure job is acquired and the secure job is transmitted to the registration destination printer. The secure job includes print data of a PDL form generated on the basis of the specifications of each of the printers, and information representing that the print job is a secure job. After step S103, the job transmission process ends.

If the print job is not a secure job (No in step S102), in step S111, the print job is transmitted to the printer selected as the transmission destination. After step S111, the job transmission process ends.

### Job Reception Process (Printer)

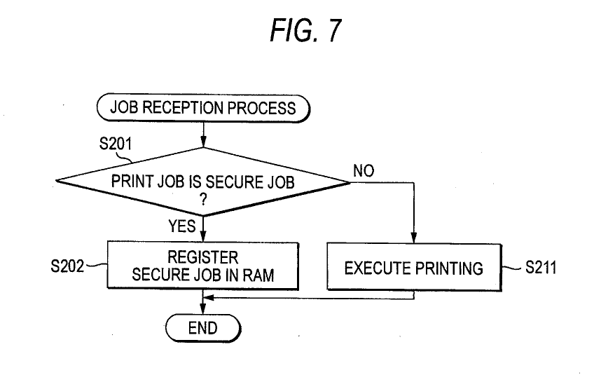

Subsequently, a job reception process executed by the firmware 211 of the printer 201 will be described with reference to a flow chart of FIG. 7. The job reception process is executed in response of reception of a print job transmitted from the PC 100.

First, in step S201, it is determined whether the received print job is a secure job or not. If the print job is not a secure job (No in step S201), in step S211, printing of the received print job starts. After step 211, the job reception process ends.

If the received print job is a secure job (Yes in step S201), in step S202, the secure job is registered in the RAM 33. That is, the print data and the user information are stored in the printer DB 216. At this time, information on a reference flag is added. An initial value of the reference flag is in an ON state. After the registration of the secure job, the job reception process ends.

In other words, after receiving a print job which is not a secure job, the printer 201 immediately starts printing, and after receiving a secure job, the printer 201 does not immediately start printing, but stores the secure job in the memory and becomes a printing instruction waiting state.

### Job Display Process (Printer)

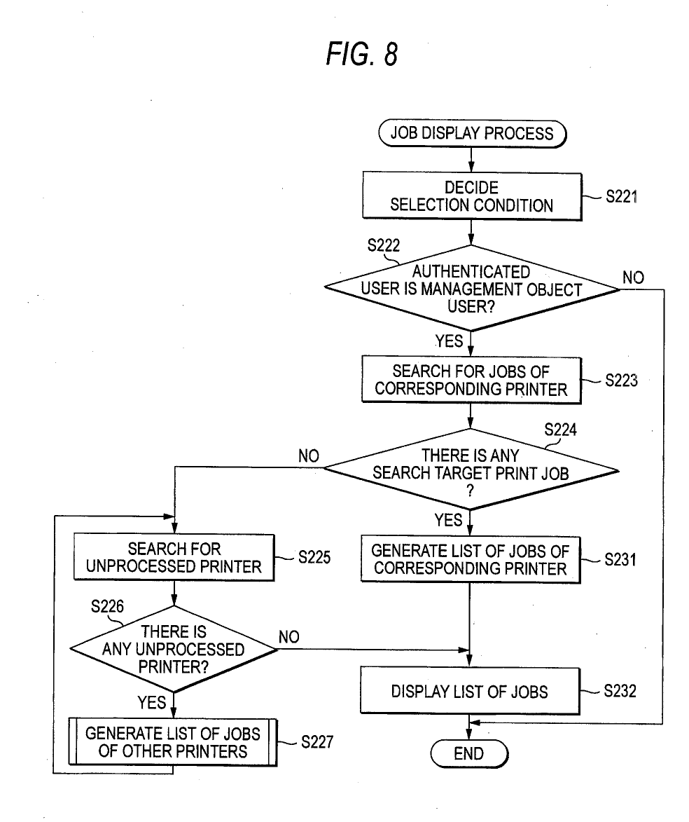

Subsequently, a job display process (an example of a decision unit, a determination unit, a notification unit, and an instruction unit) executed by the firmware 211 of the printer 201 will be described with reference to a flow chart of FIG. 8.

The printer 201 executes user authentication for printing the secure job. If the user is authenticated through the user authentication, the job display process is executed. The printer 201 receives an identification number necessary for identifying the user, for example, by manual input using the manipulation panel 40 or input through wireless communication using an IC tag or the like. Then, the user is identified on the basis of the identification number.

First, in step 221, a selection condition of the print job is decided. In the present embodiment, a user ID of the user identified by the user authentication is acquired. Then, in step S222, it is determined whether the authenticated user is a management object user registered in the management DB 215. If the authenticated user is not a management object user (No in step S222), the job display process ends. That is, printing of any secure jobs by users other than the management object users is prohibited.

If the authenticated user is a management object user (Yes in step S222), in step S223, the printer DB 216 is searched for print jobs (secure job in the present embodiment) of the authenticated user. Then, in step S224, it is determined whether there is any search target print job or not.

If the is any search target print job (Yes in step S224), in step S231, the printer 201 generates a list of the print jobs searched in step S223 as a list of jobs registered in the printer 201. Then, in step S232, the list of jobs of the printer 201 generated in step S231 is displayed in the display unit of the manipulation panel 40. After step S232, the job display process ends.

Meanwhile, if there is no search target print job (No in step S224), the printer 201 inquires of the other printers about information on print jobs of the authenticated user. Specifically, first, in step S225, the printer 201 searches for inquiry destination printers. In the present embodiment, the printer 201 extracts one printer (unprocessed printer), which has not received the inquiry, from the other printers of the same group as that of the printer 201, with reference to the management DB 215.

If there is any unprocessed printer (Yes in step S226), in step S227, the printer 201 inquiries of an unprocessed printer about information on print jobs of the authenticated user, and executes a process of generating a list of jobs of the other printers.

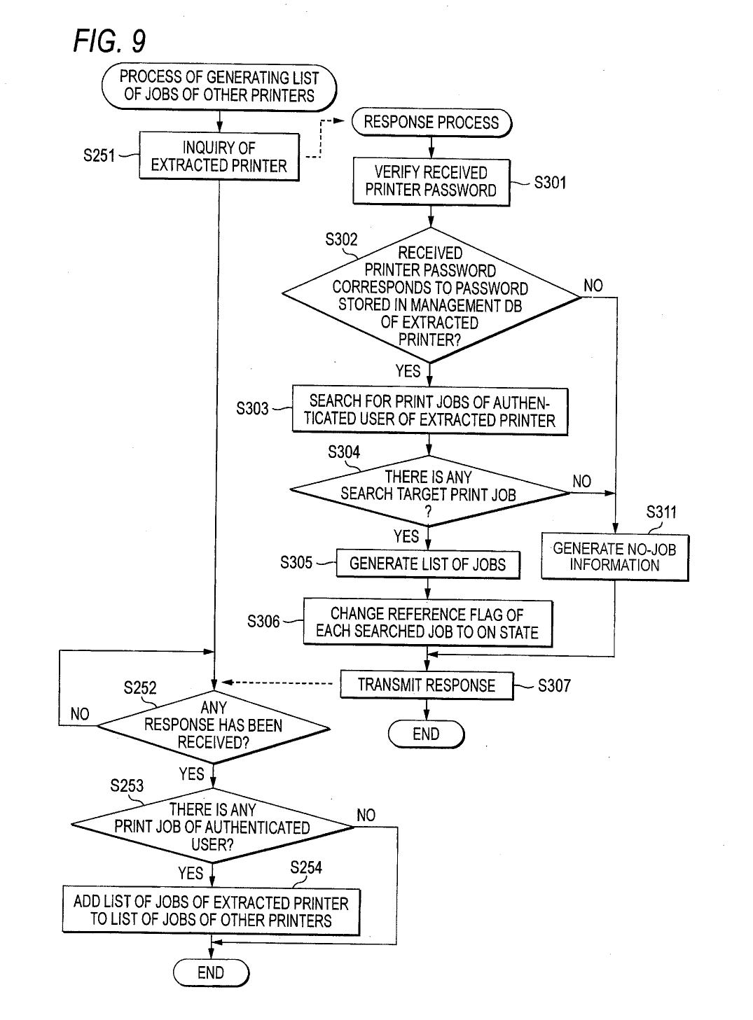

Here, the process of generating a list of jobs registered of the other printers in step S227 will be described with reference to a flow chart of FIG. 9. First, in step S251, the printer 201 inquires of an extracted printer, which is an unprocessed printer extracted in step S225, about whether any print jobs of the authenticated user has been registered or not. At the time of this inquiry, the printer password and the user ID of the authenticated user are added. After the inquiry in step S251, in step S252, the printer 201 stands by until the extracted printer responds to the inquiry.

Meanwhile, if receiving the inquiry of step S251, the extracted printer executes a response process (an example of an extraction unit). In the response process, first, in step S301, the received printer password is verified, and in step S302, it is determined whether the received printer password corresponds to a printer password stored in the management DB 215 of the extracted printer. That is, it is checked whether the printer 201 is a printer belonging to the same group as that of the extracted printer.

If the received printer password does not correspond to the printer password stored in the management DB 215 of the extracted printer (No in step S302), the extracted printer generates no job information representing that there is no corresponding print job, in step S311, and transmits the no-job information to the inquirer printer in step S307. If a printer responds information on print jobs of the authenticated user to an inquiry from another printer which does not belong to the same group as that of the corresponding printer, the information on the print jobs of the authenticated user may be leaked, and thus the confidentiality of the secure job may be lack. For this reason, regardless of the print job registration status, a printer responds the no job information to an inquiry from another printer which does not belong to the same group as that of the corresponding printer.

If the received printer password corresponds to the printer password stored in the management DB 215 of the extracted printer (Yes in step S302), in step S303, the extracted printer searches its printer DB 216 for print jobs of the authenticated user. Then, in step S304, it is determined whether there is any search target print job.

If there is any search target print job (Yes in step S304), in step S305, the extracted printer generates a list of the print jobs searched for in step S303, as a list of jobs registered in the extracted printer. Then, in step S306, as a process on the extracted printer, the reference flag of each print job searched for in step S304 is changed to the ON state.

Nest, in step S307, the extracted printer responds information on the list of jobs to the inquirer printer. In the case of responding the information on the list of jobs, the printer name of the extracted printer and the installation location of the extracted printer other than the information on the list of jobs are added. The printer name and the installation location are stored in the printer DB 216.

Meanwhile, if there is no search target print job (No in step S304), the extracted printer generates the no-job information in step S311, and responds the no-job information to the inquirer printer in step S307. After step S307, the response process of the extracted printer ends.

Returning to the description of the process of generating a list of jobs of the other printers, if a response has been received from the extracted printer (Yes in step S252), in step S253, it is determined whether there is any print job of the authenticated user. If there is any print job of the authenticated user (Yes in step S253), that is, if the information on the list of jobs has been received from the extracted printer, in step S254, the received information on the list of jobs is added to the list of jobs of the other printers. After step S254, or if there is no print job of the authenticated user in the extracted printer (No in step S253), that is, if the no-job information is received from the extracted printer, the process of generating the list of jobs of the other printers ends.

Returning to the description of the job display process of FIG. 8, after the list of jobs of the other printers is updated in step S227, the job display process returns to step S225, in which an unprocessed printer is searched for again. If there is any unprocessed printer (Yes in step S226), in step S227, the process of generating the list of jobs of the other printers is executed. That is, the process of generating the list of jobs of the other printers is repeated until there is no unprocessed printer.

If there is no unprocessed printer (No in step S226), in step S232, the finally updated list of jobs of the other printers is displayed on the display unit of the manipulation panel 40. After step S232, the job display process ends.

That is, in the job display process, if the print jobs of the authenticated user have been registered in the printer 201, the list of print jobs of the authenticated user registered in the printer 201 is output. Meanwhile, if any print jobs of the authenticated user have not been registered in the printer 201, the list of print jobs of the authenticated user registered in the other printers is output.

### Display Examples

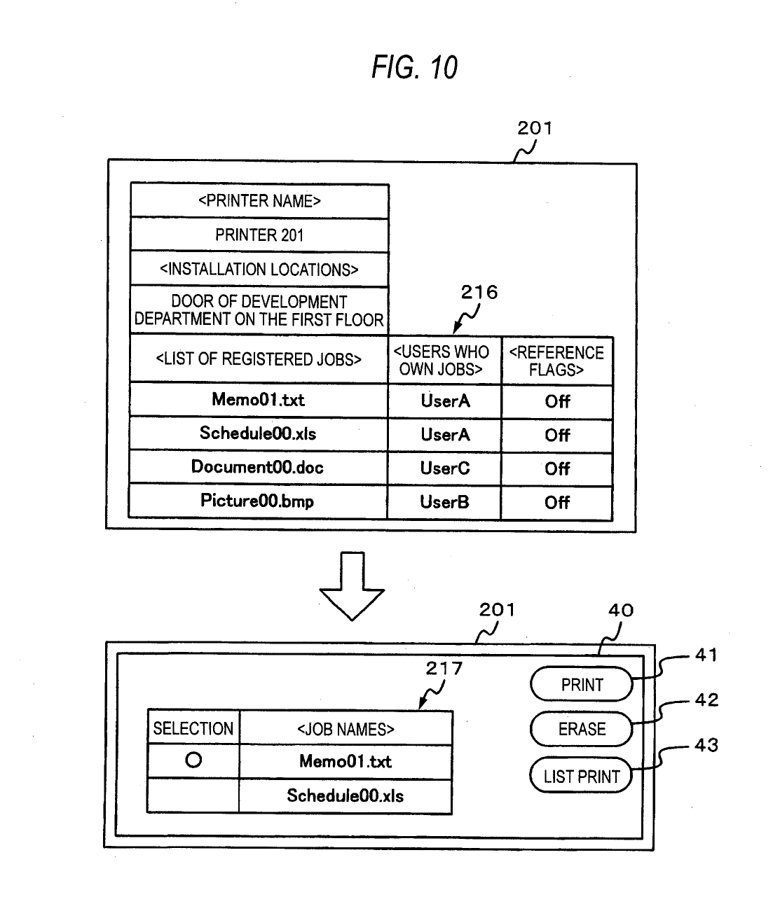

Hereinafter, examples of the display in step S232 will be described. For example, it is assumed that a user A performs printing in the printer 201. Also, it is assumed that a plurality of print jobs including print jobs of the user A have been registered in the printer 201, as shown in FIG. 10.

In this case, in the job display process, the print jobs of the user A are extracted from the printer DB 216, and a list of print jobs of the user A is generated as the list 217 of jobs of the printer 201. Then, the contents of the list 271 of jobs of the printer 201 are output on the display unit of the manipulation panel 40.

At this time, on the display unit of the manipulation panel 40, as shown in FIG. 10, a print button 41, an erase button 42, and a list print button 43 are displayed. If the print button 41 is pushed, printing of a selected print job starts. If the erase button 42 is pushed, the selected print job is erased from the memory. With this erase, a corresponding record is erased even from the list 217 of jobs of the printer 201 and the printer DB 216. If the list print button 43 is pushed, the contents of the list 217 of jobs of the printer 201 are printed.

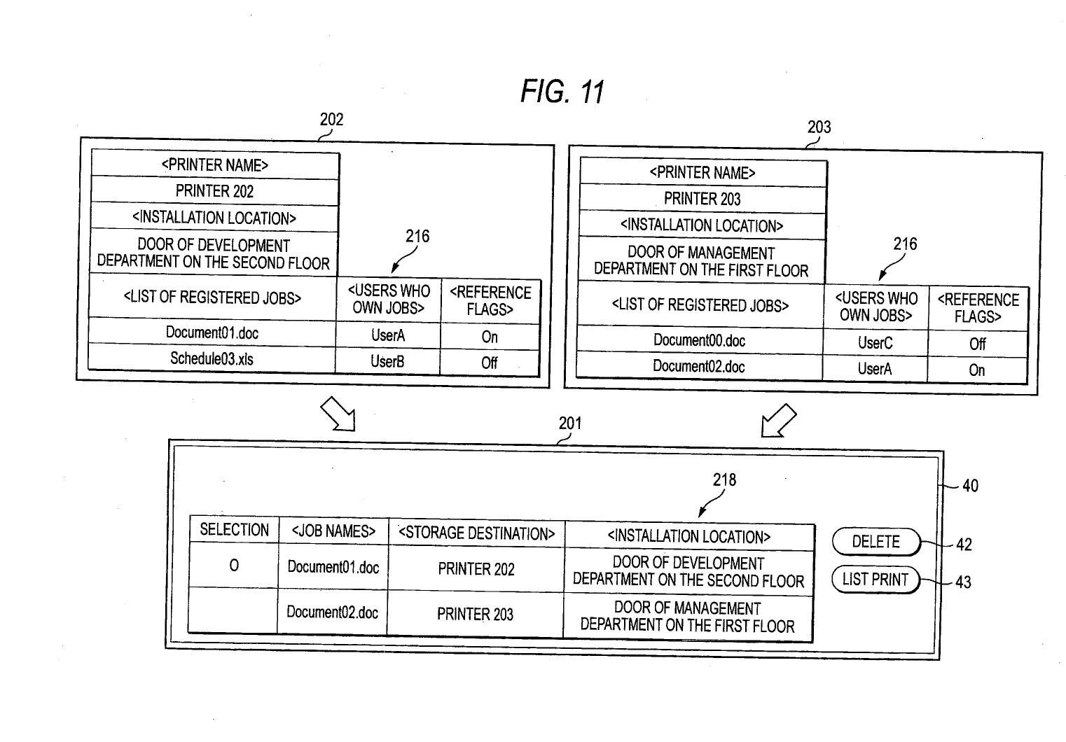

Meanwhile, it is assumed that any print jobs of the user A has not been registered in the printer 201. Also, it is assumed that a plurality of print jobs including a print job of the user A have been registered in each of the printers 202 and 203, as shown in FIG. 11.

In this case, in the job display process, the printer 201 inquires of the printers 202 and 203 about whether there is any print job of the user A, and acquires a list of print jobs of the user A generated by each of the printers 202 and 203. Then, the printer 201 generates a list 218 of jobs of the other printers which is a list of print jobs of the user A existing in the other printers. Then, the printer 201 outputs the contents of the list 218 of jobs of the other printers to the display unit of the manipulation panel 40. Also, the printer 201 acquires information on the printer names and the installation locations from the other printers 202 and 203 having received the inquiry. Then, when displaying the list 218 of jobs of the other printers, the printer 201 displays each print job in association with which printer the corresponding print job has been registered in, and where the corresponding printer has been installed, as shown in FIG. 11.

Further, on the display unit of the manipulation panel 40, as shown in FIG. 11, the erase button 42 and the list print button 43 are displayed. If the erase button 42 is pushed, an erase instruction for a selected print job is output to another printer in which the selected print job has been registered. With this, a corresponding record is erased even from the list 218 of jobs of the other printers. If the list print button 43 is pushed, the contents of the list 218 of jobs of the other printers are printed.

Items and layouts displayed on the display unit of the manipulation panel 40 are not limited to those shown in FIGS. 10 and 11. That is, at least identification information of each printer in which any print job of the identified user has been registered may be displayed, and the print job name, the installation location, and the like may not be necessarily displayed. Alternatively, display items such as detailed information (such as the number of pages and the registration date and time) of each print job may increase.

While the list 218 of jobs of the other printers is being displayed, the print button 41 is not displayed in consideration of the confidentiality. That is, the user of a printer in which a print job has been registered may be a malicious person (for example, a person having a stolen employee ID card). Therefore, it is undesirable to unconditionally permit printing. For this reason, the print button 41 is not displayed, such that printing by remote manipulation or printing of a print job transmitted from another printer is not executed.

### Registered-Job Printing Process (Printer)

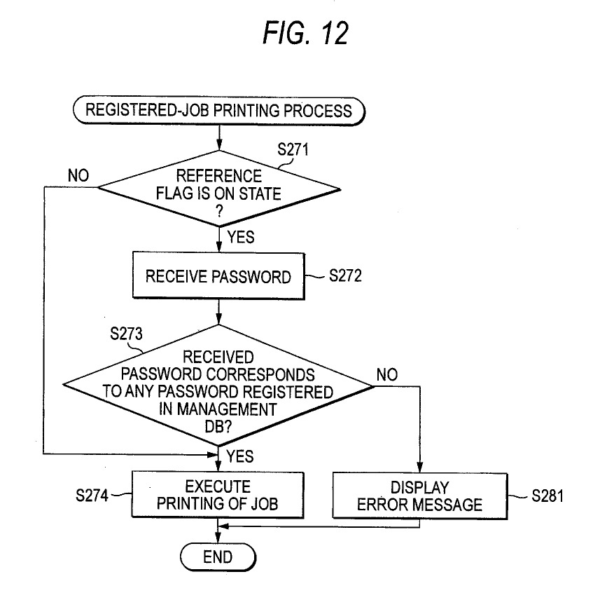

Subsequently, a registered-job printing process (an example of a prohibition unit) executed by the firmware 211 of the printer 201 will be described with reference to a flow chart of FIG. 12. If the print button 41 displayed on the display unit of the manipulation panel 40 of the printer 201 is pushed, the printer 201 can print the print job registered in the printer 201. If the print button 41 is pushed, the registered-job printing process is executed.

First, in step S271, it is determined whether the reference flag of the print job of which printing has been instructed is the ON state or not. A reference flag of a print job searched for by a printer having received an inquiry about print jobs of a specific user from another printer becomes the ON state (see step S306 of FIG. 9). If the reference flag is the OFF state (No in step S271), the printer 201 starts printing of the selected print job in step S274, and ends the registered-job printing process.

If the reference flag is the ON state (Yes in step S271), in step S272, the printer 201 receives an input of a user password. As described above, an inquiry from another printer may be attributable to a malicious person. For this reason, with respect to a print job which is an object of an inquiry from anther printer, the printer 201 requires an input of a user password before printing, so as to improve the confidentiality of the print job.

After the input of the password is received, in step S273, it is determined whether the received password corresponds to any user password registered in the management DB 215. If the received password corresponds to any user password registered in the management DB 215 (Yes in step S273), in step S274, printing of the selected print job starts. Meanwhile, if the received password does not correspond to any user password registered in the management DB 215, in step S281, an error message is displayed without printing the selected print job. After step S274 or S281, the registered-job printing process ends.

According to the printing system 500 of the present embodiment described above, a printer acquires the whereabouts of a print job corresponding to the selection condition (a print job of the authenticated user in the present embodiment) in the other printers, and notifies the acquisition result to the display unit of the manipulation panel 40. Accordingly, the user can grasp a printer in which a print job corresponding to the selection condition has been registered. Therefore, for example, after registering a printer job, even if the user forgets a registration destination printer of the printer job, the user can see the whereabouts of the print job without returning to a registration source to check a history. As a result, the desired print job can be reliably printed.

In a case where the user forgets to instruct printing after registering a print job, the print job may be left in the memory of the printer without being printed for no matter how long time. However, according to the printing system 500 of the present embodiment, the registration statuses of the other printers are notified, such that the user can recognize the existence of a print job of which printing has been forgot by the user.

The present embodiment is merely an example, and does not limit the present invention. Therefore, the present invention can be improved and modified in various forms without departing from the scope. For example, the printer may be any device, such as a combined device or a copy machine, having a print function. Also, the information processing apparatus is not limited to a PC, but may be a portable information terminal or a workstation.

In the embodiment, the present invention is applied to a printing system which registers a secure job in a predetermined printer; however, the registered print job is not limited to a secure job. That is, the present invention is applicable to any system in which a print job is registered in a designated printer, and the printer starts printing in response to a printing instruction of the print job, and the print job may not require authentication to start printing.

In the embodiment, the selection condition for print jobs to be notified is print jobs of the authenticated user; however, the present invention is not limited thereto. For example, the selection condition may be a registration time of a print job or the kind of print data.

In the embodiment, a print job is registered in one printer of a group, but a registration destination of a print job is not necessarily one. That is, a print job may be simultaneously registered in a plurality of printers. In this case, if printing of the print job is executed in one of the registration destination printers, the other registration destination printers are instructed to erase the corresponding print job.

In the embodiment, in a case where the print job of the authenticated user has not been registered in a printer, the printer inquires of the other printers about print jobs of the authenticated user. However, the condition for inquiring of the other printers is not limited thereto. For example, regardless of the registration status of a printer, after each time a selection condition is decided, the corresponding printer may inquiry of the other printers about the registration statues of print jobs corresponding to the selection condition. Alternatively, the inquiring may be executed on the basis of an instruction of the user, not immediately after a selection condition is decided.

In the embodiment, a printer directly inquires the other printers about whether there is any print job corresponding to the selection condition; however, the present invention is not limited thereto. For example, in a case of disposing a centralized printer server for managing registration statues of printing jobs of all the printers of a group, inquiring of the printer server may be executed.

What is claimed is:

1. A printing system comprising:
a first printer; and
an information processing apparatus configured to register a print job in the first printer,
wherein the first printer comprises:
a decision unit configured to decide a selection condition for selecting the print job to be printer;
a determination unit configured to determine whether the print job corresponding to the selection condition decided by the decision unit is registered in a second printer; and
a notification unit configured to notify a user of identification information of the other printer if the determination unit determines that the print job corresponding to the selection condition is registered in the second printer,
wherein the first printer to which the print job is registered starts printing in response to a print instruction.

2. The printing system according to claim 1, wherein
if the print job corresponding to the selection condition is not registered in the first printer, the determination unit determines whether the print job corresponding to the selection condition decided by the decision unit is registered in the second printer.

3. The printing system according to claim 1, wherein the notification unit notifies the print job corresponding to the selection condition in association with identification information of the second printer in which the print job is registered.

4. The printing system according to claim 1, wherein the determination unit inquires of the second printer about where the print job corresponding to the selection condition is registered in a third printer.

5. The printing system according to claim 1, wherein the first printer includes an instruction unit configured to instruct the second printer to erase the print job which is determined as corresponding to the selection condition by the determination unit.

6. The printing system according to claim 1, wherein the notification unit prints contents of the notification information on a sheet.

7. The printing system according to claim 1 or 2, wherein the second printer includes:
an extraction unit configured to extract the print job corresponding to the selection condition from registered print jobs in response to an inquiry from the printer about whether there is the registered print job corresponding to the selection condition; and
a prohibition unit configured to instruct a user to input a password for printing the print job extracted by the extraction unit, and prohibits printing if the input password is not correct.

8. A printer comprising:
a storage configured to store printing jobs therein;
a decision unit configured to decide a selection condition for the printing job to be printed;
a printing instruction unit that instructs printing of the print job which is stored in the printing job and corresponds to the selection condition decided by the decision unit;
a printing unit configured to execute printing in response to an instruction of the printing instruction unit;
a determination unit configured to determine whether the print job corresponding to the selection condition decided by the decision unit is registered in any other printer; and
a notification unit configured to notify a user of identification information of the other printer if the determination unit determines that the print job corresponding to the selection condition is registered in the other printer.
